(19) United States
(12) Patent Application Publication
(10) Pub. No.: US 2005/0251330 A1
(43) Pub. Date: Nov. 10, 2005

(54) Internet package tracking system

(76) Inventors: Paul Waterhouse, Copetown (CA); David Cramer, Orangeville (CA); Christopher W. Verge, Hamilton (CA); Michael J. Vandenberg, Erin (CA); Kenneth Truong, Scarborough (CA); John K. Stevens, Stratham, NH (US); Jason August, Toronto (CA)

Correspondence Address: OPPEDAHL & LARSON LLP- VAI, P.O. BOX 5068, DILLON, CO, 80435-5068, US

(21) Appl. No.: 10/826,222

(22) Filed: Apr. 17, 2004

Related U.S. Application Data
(60) Provisional application No. 60/463,665, filed on Apr. 17, 2003.

(51) Int. Cl. G01C 21/26

(52) U.S. Cl. 701/204; 342/357.07

(57) ABSTRACT

The invention provides a real-time package tracking system for use by a package delivery service. The system includes a vehicle operable to deliver a package to a destination of a customer within a region, a positional location system (e.g. GPS) carried by the vehicle, the positional location system being operable to determine geographic positional coordinates for sequential locations of the vehicle along the route thereof toward said destination. The system also includes a wireless transmitter means (such as a cell phone link) carried by said vehicle, for transferring the aforesaid geographic positional coordinates to a central computer. The computer is operable to providing periodic updated calculations to periodically estimate corresponding estimated arrival time (ETA) data for the specific package to said destination and to supply the aforesaid estimated arrival time data to said customer. According to preferred embodiment, the customer can view a map with the ETA information and can make selections on line (e.g. new ETA, or complete cancellation of delivery). These choices are then used to recalculate the drivers route, and can be displayed for both the dispatcher and the driver as well.

### FIELD OF THE INVENTION

This invention relates to a novel system for tracking packages carried by vehicles, such as delivery trucks, and for providing customers with estimated times of arrival for packages over the internet.

### BACKGROUND OF THE INVENTION

One of the most expensive problems faced by the courier/delivery industry, is attempted and failed deliveries to residential addresses. In the current system, a delivery agent may schedule 20 deliveries in the morning and 20 deliveries in the afternoon, provide the customers with an estimated time usually described as morning or afternoon or, in some of the more sophisticated scheduling systems, a delivery window of an hour or two may be provided. However, often traffic, weather and other problems may lead to delays that are unexpected, even though much of this traffic and weather information is usually readily available in major cities. Moreover, when the delivery agent finally arrives at the address, if he is unable to leave the package, then a card is typically left behind asking the person to phone and arrange the time for a second delivery. This so-called “carding” for second deliveries can become quite costly and may raise prices by as much as 20 to 30 percent for attempted residential deliveries.

Additionally, one of the most important services customers request when shipping a parcel is the ability to track its progress through the supply chain. Most delivery agents such as Federal Express, can provide details regarding time of pickup, time the package was delivered to the distribution center and, in some cases, the time the package left the distribution center to be delivered to the customer. As stated above, in many cases the customer is provided with a window of likely delivery. Thus, current tracking systems simply provide “signpost” snapshots of a package as it moves through the supply chain, with little or no accurate estimates of actual arrival time.

Many advanced delivery systems have been created for routing delivery to a sequence of addresses based on digital maps and GPS coordinates. These systems are used at the beginning of the day to dispatch the courier and to plan stops as the day progresses. In many cases, the same systems are also used to estimate time of arrival, providing both the driver and the customer with a rough estimate of scheduled arrival of a package at the customer's destination.

Several companies provide active route calculation from one point to another online. In other words, an individual can logon to a website for a delivery to an arbitrary address, and get detailed routing interactions with a full online map to the indicated address.

### SUMMARY OF THE INVENTION

The present invention makes use of a Global Positioning System (GPS) connected to a wireless digital transmission means capable of transmitting the GPS coordinates of the vehicle in real time to a server or centrally located computer. In the morning the delivery vehicle obtains a print-out from the server of the stops and routes (drivers routing) for the day. Alternatively, the server may also provide an in-truck computer with a display and a map with the routing for the day. The server has all of the stops that the delivery vehicle is scheduled to make for its delivery route, plus the likely route planned stored on a disk. As the driver follows the route, the GPS coordinates of his truck and its packages are transmitted back to the server on a regular basis and the Estimated Time for Arrival (ETA) for each stop is recalculated periodically ( e.g. every few minutes). Advantageously, these ETA values may be provided to customers who are expecting packages in real time as they are updated, via the web or other similar means. This information may be combined with other details such as size and number of packages and specific items to be delivered. Thus, any customer who is expecting a package can, in the preferred embodiment, log on to a web site, and optionally see the current location of the truck as well as the current calculated ETA of the package as the day progresses. A customer may view this information from a distant site (e.g. work) and be able to plan the time to be home to receive the package based on this ETA.

It may also be advantageous to use weather and traffic information when these routes are recalculated to provide even better ETA's as the day progresses. In a more advanced version of the invention the customer may also be able to supply information on-line that he will be home or someone will be home to accept the package, or alternatively that he will have to cancel the delivery because it is not within a convenient window of time. In this case, the server can dynamically update the routing in the truck to indicate to the driver that this stop may be skipped, and will be rescheduled the next day. This will provide the customer with a better estimate of when the customer should be home to receive the package. Moreover, the server can calculate, in real time, an optimized route for the delivery vehicle from one stop to the next

The present invention broadly provides a package tracking system comprising:
a) a vehicle operable to deliver a package to a destination of a customer within a region;
b) a positional location system (e.g. a global positioning system ( GPS)) carried by said vehicle, said positional location system being operable to determine geographic positional coordinates for sequential locations of said vehicle along the route thereof toward said destination,
c) a wireless transmitter means, carried by said vehicle, for transferring said geographic positional coordinates to a central computer; and
d) a computer (e.g. server) operable to providing periodic updated calculations to periodically estimate corresponding estimated arrival time (ETA) data for said package to said destination, said computer being operable to supply said estimated arrival time data to said customer.

According to a preferred embodiment, the aforesaid computer is in operative communication with an internet router operable to supply the aforesaid estimated arrival time (ETA) data to the customer via an internet website.

Preferably, the aforesaid computer is operable to provide the aforesaid ETA data in a representation of positional indicia depicting a current vehicle position superimposed upon a map of said region.

According to a preferred embodiment, the aforesaid computer is operable to receive commands from said customer to modify delivery time or cancel delivery of said package to said destination

According to another preferred embodiment, the aforesaid computer/server is carried by the delivery vehicle.

Preferably, the aforesaid computer is operable to provide the driver with dynamic routing information via text or graphics information during the course of a delivery, in response to commands from a customer (e.g. cancellation, change of desired ETA) or from a dispatcher.

The invention also broadly provides a method for tracking delivery, with a vehicle, of a package to a destination of a customer within a region, the aforesaid method comprising the steps of:
a) placing said package on a vehicle operable to deliver said package to said destination of said customer within a region;
b) using a positional location system (e.g. GPS) carried by said vehicle, said positional location system being operable to determine geographic positional coordinates for sequential locations of said vehicle along the route thereof toward said destination;
c) using a wireless transmitter means carried by said vehicle, for transferring said geographic positional coordinates to a central computer; and
d) using a computer (e.g. server) operable to providing periodic updated calculations to periodically estimate corresponding estimated arrival time (ETA) data for said package to said destination, said computer being operable to supply said estimated arrival time data to said customer.

The aforesaid computer, as noted hereinabove, may be in operative communication with an internet router operable to supply said estimated arrival time (ETA) data to said customer via an internet website.

The computer is preferably operable to provide said ETA data in a representation of positional indicia depicting a current vehicle position superimposed upon a map of said region. Moreover, the computer can advantageously be operable to receive commands from said customer to modify delivery time or cancel delivery of said package to said destination

Preferably, the aforesaid computer is operable to provide the driver with dynamic routing information via text or graphics information during the course of said delivery, in response to commands from a customer or a dispatcher.

Thus, the invention provides a system and method for detection and tracking of packages in real-time. As will be understood, it does this by using a combination of a real-time GPS system located in the delivery vehicle and an estimated arrival time (ETA) provided over the Internet. In a preferred embodiment, the ETA may be provided in the form of a map that may display the current position of the delivery vehicle and the destination address for the customer. The ETA and other details about the shipping may also be provided as part of of this online report. As a delivery vehicle progresses throughout day, on its delivery route, the delivery times and stops and routing, may be dynamically updated on the Internet server, and provided to the customer as an online report. The customer may therefore go to work in the morning and monitor the actual location and progress of his or her package throughout the day. Again, as the day progresses, the accuracy of the delivery time will typically improve.

As an option, the customer may also elect to cancel delivery online, and may request a new time and new day if the ETA becomes inconvenient. This allows the driver to skip a stop if he knows in advance that the customer will not be able to accept a delivery. This interactive two-way customer/driver system has the potential to virtually eliminate failed stops, and provide customer with a valuable narrow estimate of delivery time. Thus, this system allows dynamic customer-assisted routing that minimizes his/her inconvenience and also reduces cost to the delivery agent, who usually bears responsibility for failed deliveries.

Many delivery agents have been un-willing to install GPS systems in vehicles despite the clear value in dispatch and routing vehicles simply because the cost does not justify the benefits. However, one of the unexpected values and economic benefits of this invention is that it has the ability to reduce or eliminate (a) one of the most expensive problems in the industry, namely, “carding” as well as (b) one the most annoying problems faced by customers as well, namely, staying home all afternoon or morning to accept a delivery whose ETA is only very roughly predictable.

### DESCRIPTION OF THE DRAWINGS

FIG. 1 is a schematic of elements of a package tracking system in accordance with the present invention.

FIG. 2 is map showing positional indicia representing positions of customer delivery destinations and a predictive route for a delivery vehicle.

FIG. 3 is a map showing delivery destination, current real-time location of the delivery vehicle and the Expected Time of Arrival (ETA) for the package of a specific customer “N”, who is logged into the internet web site of a delivery service that provides a package tracking system in accordance with the present invention .

FIG. 4 is a map showing delivery destination, current real-time location of the delivery vehicle and three choices of Expected Time of Arrival (ETA), and options to cancel delivery and receive notifications, for the package of a specific customer “N”, who is logged into the internet web site of a delivery service that provides a package tracking system in accordance with the present invention.

FIG. 5 is schematic block diagram view of the in-truck system and map for viewing by the vehicle driver.

### DESCRIPTION OF PREFERRED EMBODIMENTS

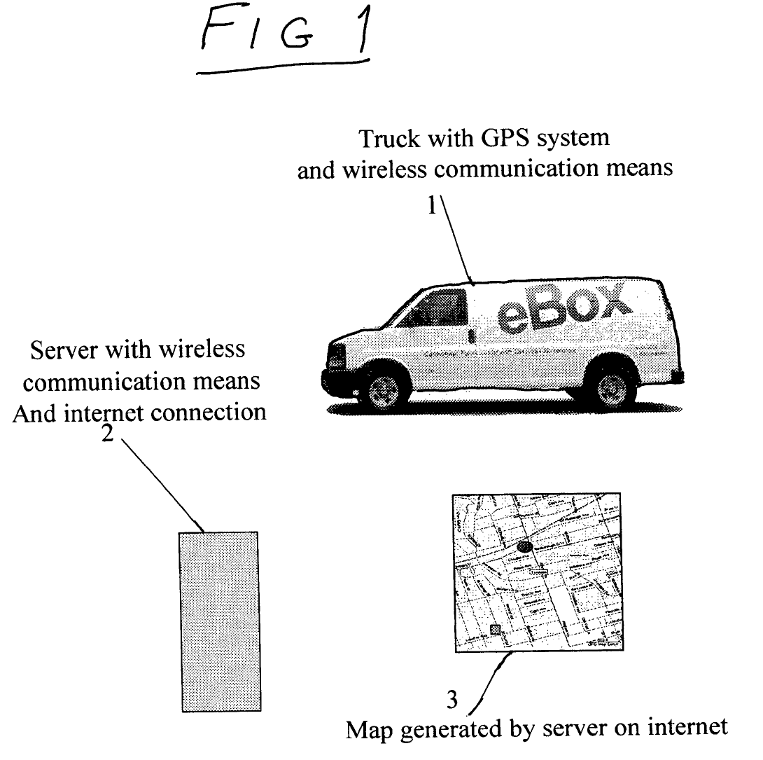

FIG. 1 shows a truck 1 as a vehicle equipped with both a global positioning system (GPS), for determining the current position of truck 1 based on satellite positional signals, and a wireless communication means (such as a cell phone). The wireless communication means is in wireless radio frequency communication with a centrally located server (computer) 2 that may also be optionally connected to the internet. The server may generate an online web-enabled map 3 showing both the real-time, current location of the vehicle and location of the customers delivery site.

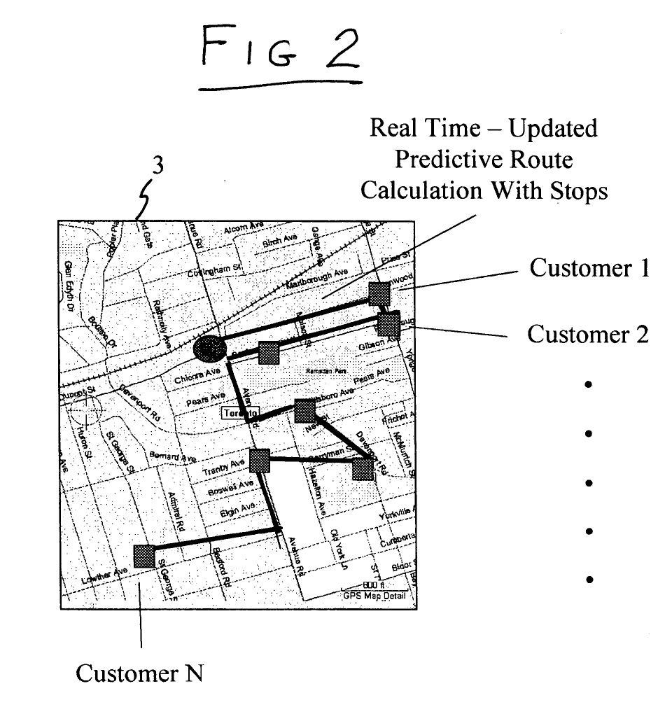

The centralized server computer 2 continuously updates vehicle location and monitors the time associated with each stop. It recalculates the expected time of arrival (ETA) of packages for each of customers 1,2, . . . N on a periodic basis. As shown in FIG. 2, these locations may be displayed on map 3 for a dispatcher at a central monitor, and for the truck driver if desired, in real time in a predictive route calculation with stops.

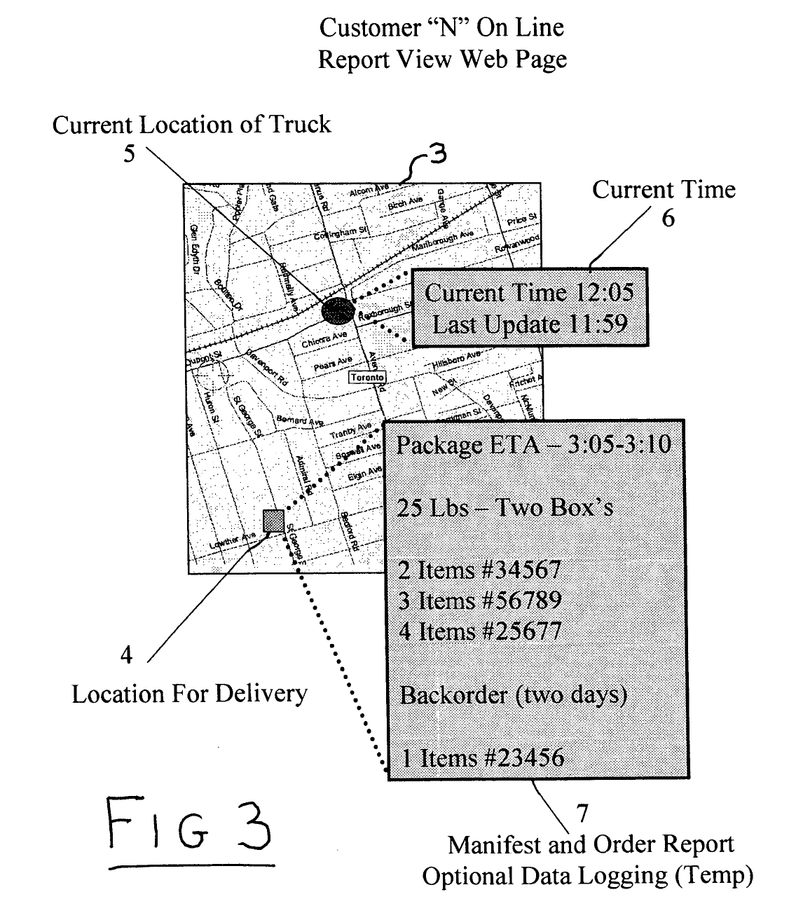

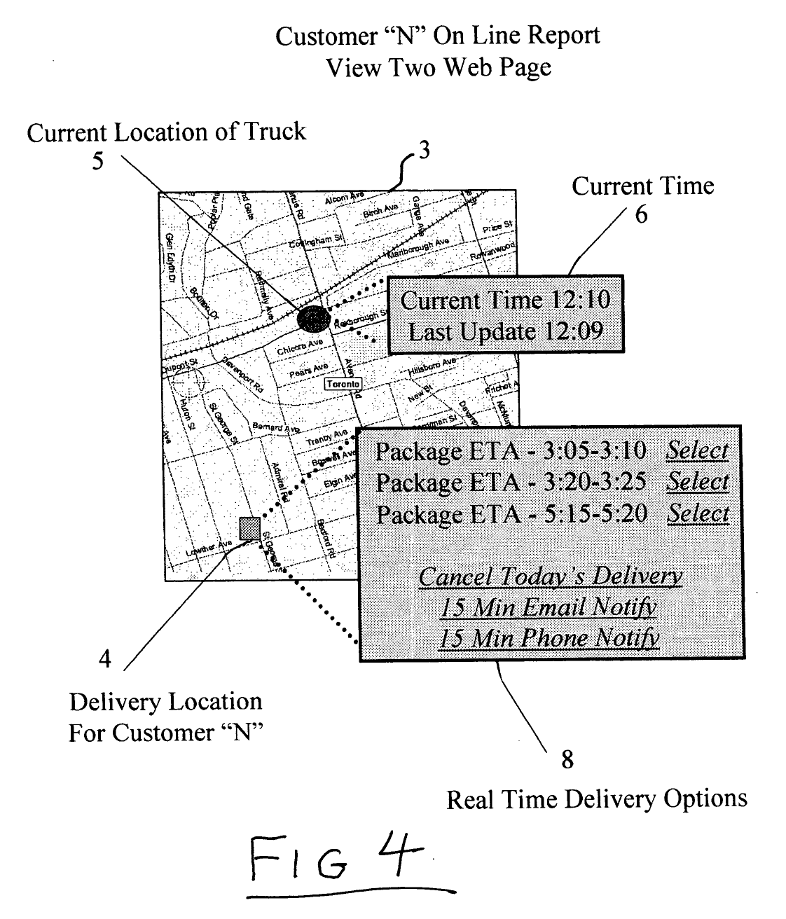

An individual customer “N” may logon to the internet website of a delivery service that provides a package tracking system in accordance with the invention in order to view a map 3 with the delivery destination 4 and the current location 5 of the truck as it progresses through the route, as shown in FIG. 3. However, the system does not display details associated with other customers on the route but provides the inquiring customer with the current calculated ETA as well as optional details about only customer N's package, as shown at 6 and 7, such as details of items contained in the packages, and any backordered items. In a preferred embodiment, the customer may also have the ability to submit an indication on the website that they wish to cancel delivery, as shown by the clickable HTML (hyper text marker language) choices displayed at displayed report 8 in FIG. 4. In this case the centralized computer server will recalculate the routes based on the new options selected by customer N and provide the driver with updated information. Moreover, if the driver has a display screen in the delivery vehicle he may see a recalculated route dynamically changed in real time on a map 3 as individual customers select options, such as choosing to not receive packages. In a preferred embodiment, it may also be desirable to calculate multiple routes as the day goes on with multiple preferred ETA's and allow a customer to select the best one (to match the time they expect to return home and receive a package as shown among the clickable options at report 8 in FIG. 4.

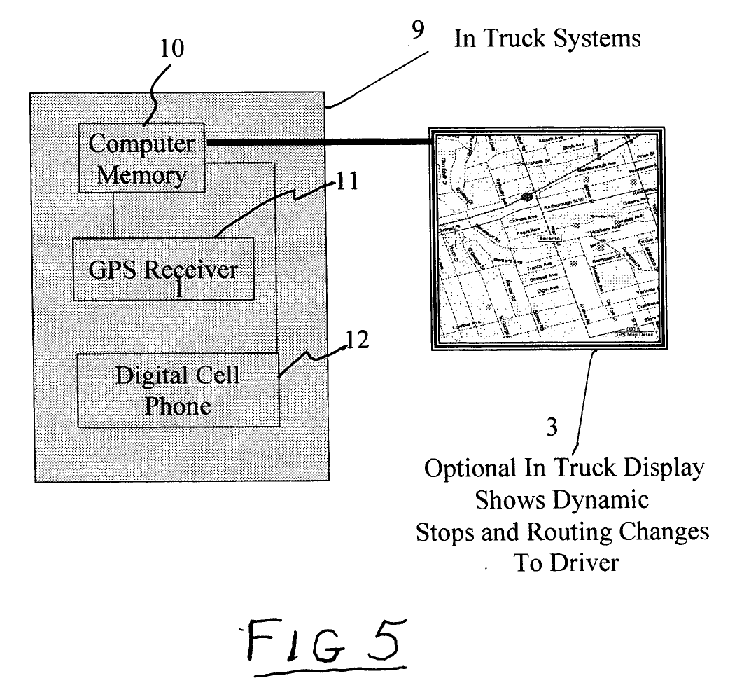

As shown in FIG. 5, each truck may also have an in-truck system 9 containing a computer 10 with memory and GPS receiver 11 and a radio frequency (RF) wireless digital link (such as a cell phone) 12 to the centrally located (e.g. at the truck depot) server that generates ETA information and map images for display. In the preferred embodiment, the truck computer may also have a display screen with display of routing on a map 3 for the driver. This may also provide the driver with interactive dynamic real-time updates of routes based on changes made by customers or by the dispatcher. These changes may be updated via the wireless digital link 12 from the centralized server.

While the present invention has been described with reference to preferred embodiments thereof, numerous obvious changes and variations may readily be made by persons skilled in the fields of delivery systems and logistics. Accordingly, the invention should be understood to include all such variations to the full extent embraced by the claims.

1. A package tracking system comprising:
a) a vehicle operable to deliver a package to a destination of a customer within a region;
b) a positional location system carried by said vehicle, said positional location system being operable to determine geographic positional coordinates for sequential locations of said vehicle along the route thereof toward said destination;
c) a wireless transmitter means, carried by said vehicle, for transferring said geographic positional coordinates to a central computer; and
d) a computer operable to providing periodic updated calculations to periodically estimate corresponding estimated arrival time (ETA) data for said package to said destination, said computer being operable to supply said estimated arrival time data to said customer.

2. A system as set forth in claim 1, wherein said positional location system comprises a global positioning system ( GPS).

3. A system as set forth in claim 1, said computer being in operative communication with an internet router operable to supply said estimated arrival time (ETA) data to said customer via an internet website.

4. A System as set forth in claim 3, wherein said computer is operable to provide said ETA data in a representation of positional indicia depicting a current vehicle position superimposed upon a map of said region.

5. A system as set forth in claim 4, wherein said computer is operable to receive commands from said customer to modify delivery time or cancel delivery of said package to said destination

6. A system as set forth in claim 1, said computer being carried by said vehicle.

7. A system as set forth in claim 2, wherein said computer is operable to provide the driver with dynamic routing information using a selection of text and graphics information during the course of said delivery, in response to commands from a customer or a dispatcher.

8. A method for tracking delivery, with a vehicle, of a package to a destination of a customer within a region, said method comprising the steps of:
a) placing said package on a vehicle operable to deliver said package to said destination of said customer within a region;
b) using a positional location system carried by said vehicle, said positional location system being operable to determine geographic positional coordinates for sequential locations of said vehicle along the route thereof toward said destination;
c) using a wireless transmitter means carried by said vehicle, for transferring said geographic positional coordinates to a central computer; and
d) using a computer operable to providing periodic updated calculations to periodically estimate corresponding estimated arrival time (ETA) data for said package to said destination, said computer being operable to supply said estimated arrival time data to said customer.

9. A method as set forth in claim 8, wherein said positional location system comprises a global positioning system ( GPS).

10. A system as set forth in claim 8, said computer being in operative communication with an internet router operable to supply said estimated arrival time (ETA) data to said customer via an internet website.

11. A method as set forth in claim 10, wherein said computer is operable to provide said ETA data in a representation of positional indicia depicting a current vehicle position superimposed upon a map of said region.

12. A system as set forth in claim 11, wherein said computer is operable to receive commands from said customer to modify delivery time or cancel delivery of said package to said destination

13. A system as set forth in claim 8, said computer being carried by said vehicle.

14. A system as set forth in claim 8, wherein said computer is operable to provide the driver with dynamic routing information using a selection of text and graphics information during the course of said delivery, in response to commands from a customer or a dispatcher
